(19) United States
(12) Patent Application Publication
(10) Pub. No.: US 2014/0274254 A1
(43) Pub. Date: Sep. 18, 2014

(54) LITERATURE CARD GAME

(71) Applicant: Amplify Education, Inc., New York, NY (US)

(72) Inventors: Justin Leites, New York, NY (US); Philip Timothy Stuart, London (GB); Sandy Cameron Lockie, London (GB); Laura Vila Rawson, New York, NY (US); Damien Yambo, Brooklyn, NY (US); Allison Fine Mishkin, New York, NY (US)

(73) Assignee: Amplify Education, Inc., New York, NY (US)

(21) Appl. No.: 14/211,264

(22) Filed: Mar. 14, 2014

Related U.S. Application Data
(60) Provisional application No. 61/882,420, filed on Sep. 25, 2013.
(60) Provisional application No. 61/798,039, filed on Mar. 15, 2013.

(51) Int. Cl. A63F 13/00

(52) U.S. Cl. CPC A63F 13/00
USPC 463/11

(57) ABSTRACT

Methods, systems, and apparatus, including computer programs encoded on a computer storage medium, for a literature card game. In one aspect, a method includes receiving a request to view a book; displaying the book on a display device. The method further includes displaying an activity indicator at a location in the book. The method further includes receiving a selection of the activity indicator. The method further includes displaying an activity on the display device, the activity being associated with the book and the location of the activity indicator within the book. The method further includes receiving a response to the displayed activity from the user; determining that the response to the activity meets specified criteria. The method further includes awarding a playing card that is associated with the book, the playing card configured to be used in a card game played by the user.

### CROSS REFERENCE TO RELATED APPLICATION

This application claims the benefit of U.S. Patent Application No. 61/798,039 filed Mar. 15, 2013 and U.S. Patent Application No. 61/882,420 filed Sep. 25, 2013, the contents of both are incorporated herein by reference.

### TECHNICAL FIELD

This specification generally relates to card games.

### BACKGROUND

Some types of cards that depict people, characters, or objects are collectable. Some people may uses these cards to play games and others may collect the cards to obtain a full set of cards.

### SUMMARY

An aspect of the subject matter described in this specification may be embodied in methods that include the actions of receiving a request to view a book; displaying the book on a display device; displaying an activity indicator at a location in the book; receiving a selection of the activity indicator; in response to receiving the selection of the activity indicator, displaying an activity on the display device, the activity being associated with the book and the location of the activity indicator within the book, where the activity is configured to solicit a response from a user; receiving a response to the displayed activity from the user; determining that the response to the activity meets specified criteria; and based on determining that the response to the activity meets the specified criteria, awarding a playing card that is associated with the book, the playing card configured to be used in a card game played by the user.

Implementations can included one or more of the following features. The playing card depicts a character from the book. The playing card depicts an author of the book. The activity indicator comprises an icon that is embedded within text of the book. The activity is a challenge question, the response is an answer to the question, determining that the response meets specified criteria includes determining that the answer is correct. Based on determining that the response to the activity meets the specified criteria, the actions include adjusting the activity indicator to indicate that the response to the activity meets the specified criteria. The activity includes an option to skip the activity. The activity indicator is located in a margin of the book. The playing card is associated with the activity. The actions further include receiving a request to view the playing card, other awarded playing cards, and other initially provided playing cards; displaying the playing card, the other awarded playing cards, and the other initially provided playing cards; and receiving, from the user, a selection of a subset of the playing card, other awarded playing cards, and other initially provided playing cards for use in the card game.

Another aspect of the subject matter described in this specification may be embodied a system that includes an electronic device that includes a display device; one or more processing devices; one or more memory devices storing instructions that, when executed by the one or more processing devices, cause the one or more processing devices to implement an e-reader configured to receive a request to view a book; display the book on the display device; display an activity indicator at a location in the book; receive a selection of the activity indicator; an activity layer module configured to in response to receiving the selection of the activity indicator, display an activity on the display device, the activity being associated with the book and the location of the activity indicator within the book, wherein the activity is configured to solicit a response from a user; receive a response to the displayed activity from the user; determine that the response to the activity meets specified criteria; and based on determining that the response to the activity meets the specified criteria, award a playing card that is associated with the book, the playing card configured to be used in a card game played by the user; and a gaming module configured to implement the card game.

Implementations can included one or more of the following features. The playing card depicts a character from the book. The playing card depicts an author of the book. The activity indicator comprises an icon that is embedded within text of the book. The activity is a challenge question, the response is an answer to the question, determining that the response meets specified criteria includes determining that the answer is correct. Based on determining that the response to the activity meets the specified criteria, the actions include adjusting the activity indicator to indicate that the response to the activity meets the specified criteria. The activity includes an option to skip the activity. The activity indicator is located in a margin of the book. The playing card is associated with the activity. The activity layer module is further configured to receive a request to view the playing card, other awarded playing cards, and other initially provided playing cards; display the playing card, the other awarded playing cards, and the other initially provided playing cards; and receive, from the user, a selection of a subset of the playing card, other awarded playing cards, and other initially provided playing cards for use in the card game.

Other embodiments of this aspect include corresponding systems, apparatus, and computer programs recorded on computer storage devices, each configured to perform the operations of the methods. The details of the other embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example computing system.

FIG. 2 is a flowchart of an example card game.

FIG. 3 is an example screen shot of a book library.

FIG. 4 is an example screen shot for reading a book.

FIG. 5 is an example screen shot of a question related to a book.

FIG. 6 is an example screen shot of card related to a book.

FIG. 7 is an example screen shot of a card collection.

FIG. 8 is an example screen shot of a card battle.

FIG. 9 is an example screen shot of puzzle.

FIG. 10 is an example screen shot of another puzzle.

Like reference numbers and designations in the various drawings indicate like elements.

### DETAILED DESCRIPTION

In general, an e-reader can be integrated with a playing card game to create an application that encourages users to read books. The application allows users to collect playing cards based on the books and use those playing cards to play games. In one example, to earn playing cards a user reads a book and answers questions related to the book. If the user answers questions correctly, then the user may be awarded a playing card. Each book has up to four cards available through answering questions. The user may continue to answer questions from the book or select a new book and answer questions from the new book to earn more playing cards.

The user may use the playing cards to play a game against other users. The cards depict characters from the books and possess actions and attributes that are comparable their depiction in the books. In one example, when playing against each other, the users select a group of their playing cards for the match. For each turn during the match, users place cards into the playing field and perform character actions. These actions can power up your cards or damage the opponent. The game play continues until the users are out of cards or one user's energy bar is depleted. At the conclusion of the game users can view the other user's card collection and link to the e-reader to read the books associated with the other user's playing cards.

FIG. 1 is a block diagram of an example computing system 100. The computing system 100 includes a display 105. The display 105 may be a touch screen display that accepts user input directly from a finger or a stylus. The computing system 100 includes a memory module 110. The memory module 110 contains memory bank 125 for storing books and memory bank 135 for storing playing cards. The memory bank 135 contains text for various books. The text is augmented with questions that pertain to the text, and each question is associated with a playing card. A user can read a book as the system 100 displays the text on the display 105. The user can select an icon included in the text to display a question. If the user answers a question correctly, then the user is awarded a playing card depicting a character from the book.

The memory bank 125 contains a section for the books in a particular user's virtual library. A user can add a book to the virtual library by downloading a book from an electronic book store that contains books augmented with questions for earning playing cards. The memory bank 135 contains a section for the playing cards in a particular user's card collection. The user's card collection may be displayed on the display 105. The user can view each character and the attributes of each playing card. The user can also view empty slots indicating unearned playing cards. The empty slots may link to the electronic book store so that the user can view the book associated with the empty slot. The user can download the book, begin reading the book, and answer questions to earn playing cards to fill the empty slot.

The system 100 includes an activity layer module 115. The activity layer module 115 operates the e-reader application and the card earner application. In some implementations, the activity layer module 115 includes the card earner application and the activity layer module 115 is separate from the e-reader application. The e-reader application displays a virtual library on the display 105. The user can select a book from the virtual library to read. The e-reader displays small icons within the text that the user can select to initiate the card earner application. The card earner application presents a question in response to the user selecting one of the small icons. If the user answers the question correctly, then the card earner application awards the user with a playing card related to the book. The activity layer module 115 stores the card in the memory bank 135.

The system 100 includes a gaming module 120. The gaming module 120 operates the playing card game. The playing card module allows different users to compete against each other in a card game involving the playing cards that each user has earned from reading books. The playing card module also allows a single user to compete against a computer player. The gaming module 120 connects to the memory bank 135 to determine the playing cards that are available to a user for a game. The gaming module 120 allows the user to select a specific number of playing cards from the user's playing card collection and use the selected card in a game. During each turn of the game, the gaming module 120 determines a winner. If the cards of the competing users are exhausted, the gaming module 120 determines a winner. At the conclusion of the game, the gaming module 120 accesses the memory bank 135 and allows each user to view the other user's card collection. The gaming module 120 identifies the books that are related to each playing card and allows the user to navigate to the book store or the user's virtual library in order to read the book and earn playing cards like those of the user's opponent.

FIG. 2 is a flowchart of an example process 200 of a card playing game and playing card earner, or e-reader. In general the process 200 awards playing cards to users and allows the users to play a game with the playing cards. The process 200 will be described as being performed by a computer system, for example, computing system 100 as shown in FIG. 1.

The system receives an indication from a user to start the card playing game and playing card earner (202). The system displays a title screen when the system receives the indication to start the card playing game and playing card earner. The title screen displays the option of either starting the card playing game or the playing card earner.

The system receives an indication from a user to start the playing card earner (204). In some implementations, the playing card earner may display the playing card earner interface in an e-reader application that runs from within the process 200. In some implementations, the playing card earner may display the playing card earner interface in an e-reader application that runs within the process 200. The playing card earner interface begins with a virtual library (206). The virtual library displays a selection of electronic books that a user may read. In some implementations, the virtual library may offer the user additional books to add to the virtual library. The additional books may be offered free of charge or at a price. In some implementations, the virtual library is associated with a particular user and the virtual library displays the books in the particular user's library. For example, if a user is logged to the system and the user has ten books in the user's library, then the virtual library may display the ten books in the user's virtual library.

The system receives an indication of a user selection of a book (208). In some implementations, a user may select one of the books touching the display 105 where the book is located. In some implementations, a user may select a book by selecting the book with a pointing device such as a mouse. All the books may not be displayed on the display 105. To view additional books a user may have to scroll the virtual library. For example, the user may swipe the display 105 or touch a scroll bar to view additional books.

The system displays the selected book (210). The system displays the text of the book on the display 105. The text of the book is combined with question icon. The question icons may be located within the text, and the user may select the icons to view a question related to the book. The question icons may indicate whether the user has answered the question correctly, answered the question incorrectly, or not attempted to answer the question. In some implementations, the system may no longer display a question icon if the user has answered the question correctly. The text of the book may also include a selectable icon to return to the virtual library. If the user selects the selectable icon to return to the virtual library (212), then the user returns to the virtual library and may select another book.

When the user selects a question icon (214), the system displays a question related to the book (216). In some implementations, the question is a multiple choice question. The user selects one of the answers and if the user answers the question correctly, then the system awards the user a playing card associated with the book (218). In some implementations, the question is a true/false question. If the user answers a question incorrectly, then the system indicates the user is incorrect. The system may allow the user to retry the question or return to the text (220).

In some implementations, the questions related to the book may each be paired a specific page of the book. For example, a book may be matched with ten questions related to the book. The selectable icon linking to question one may always appear on page twenty. The selectable icon linking to question two may always appear on page thirty-two. Where a particular question is linked to a particular page, the particular question may be related to the text of that page, previous pages, or a combination of both. In some implementations, the questions relating to the book may appear in order, independent of the particular icons selected by the user. For example, if the first icon the user selects is on page forty-five, then the system displays the first question. If the second icon that the user selects is on page twenty-eight, then the system displays the second question.

When a user answers a playing card question correctly, the system awards the user a playing card. In some implementations, the awarded playing card may be associated with the question. For example, if the question relates to Sherlock Holmes, then the awarded playing card may be a Sherlock Holmes card. In some implementations, the system awards a particular card for the a correct answer from the user based on the previous number of questions answered correctly for the book, independent of which question the user answers. For example, if the user is reading The Adventures of Tom Sawyer, the system may award the third correct answer with a Tom Sawyer card, independent of whether the question is related to Tom Sawyer.

The system saves the awarded playing cards in a card inventory of the user (222). The card inventory is available for the user when playing a card playing game. The user may view (226) and arrange the cards in any order and view cards earned from different books (224). In some implementations, system may provide the user with an option of arranging the playing cards by book. In some implementations, the system may provide the user with an option of arranging the playing cards by various statistics or attributes of the playing cards.

Instead of starting the playing card earner from the title page, the user may select to start the card playing game (228) or view the user's current playing card inventory (224). If the user views the playing cards in the inventory, then the user can select playing cards for the card playing game (230). The user may select up to a particular number of playing cards to use for an upcoming match. The user may select from the playing cards that the user has earned from answering card earning questions correctly and from playing cards that each user is given when a user begins to collect playing cards. For example, a user may create an account to start collecting playing cards and the system gives the user a starter set of playing cards. The starter set of playing cards may be identical for each user or may be selected by the system at random. The starter set allows a user to play the card game before earning cards from answering questions.

The user may select any of the playing cards in the user's inventory to use in an upcoming match. A user may select cards based on what the user know about the user's opponent. If a user knows that the user's opponent has read a particular set of books and the user is familiar with the characters from that particular set of books, then the user can select playing cards that will likely perform well against playing cards depicting characters from the particular set of books read by the opponent.

Once the user has selected the playing cards for a match, the user can select either a single player match (232) or a multiplayer match (234). In a single player match, the user plays against a computer controlled player. In a multiplayer match, the user selects another user to play against. The other user should be another play who has an inventory of playing cards. In some implementations, the user may see a list of possible opponents who have an inventory of playing cards. The possible opponents may be other users who are currently online or who are associated with the user outside of the system, such as those who are in the same school or class as the user.

With the user playing a computer opponent or another user, the system determines a theme energy for a playing card battle (236). In some implementations, the system may determine the theme energy based on a die rolled by the user or the user's opponent. In some implementations, the system may determine the theme energy based on a spinner spun by one of the users. In some implementations, the system may determine the theme at random. Users collect the determined theme energy during each turn and use the theme energy to perform actions from the playing cards in the current turn or future turns. For example, if the determined theme energy is a Fall from Grace, then the user collects that theme energy. When the user plays a playing card that requires a Fall from Grace energy theme, then the play may perform that action. Theme energy may be stockpiled by users across turns in an energy pool.

The user can select one of the user's playing cards to place on the playing field (238). In some implementations, there are three to five slots for each user in the playing field and only those playing cards placed in the slots may take actions during a turn. The user selects a playing card for each slot that the user believes will be successful against the user's opponent's selected playing cards. The user can then assign a theme energy from the user's energy pool to any playing card in the playing field (240). Users learn strategies across multiple playthroughs. Knowledge of books can help a user know which playing cards are likely to come into play based on what playing cards the user's opponent has already played.

If a user has enough theme energy, a user may choose to activate a playing card action that requires that theme energy. The system resolves playing card actions (242) and determines a winner based on the actions and attributes of the selected playing cards (244). This may result in damage or defeat of the user's opponent. If one user is not defeated, then game play switches to the user's opponent and the system returns to determines a new theme energy for a subsequent turn (236). If one of the users is defeated, which may be because the defeated user has no more playing cards to play, then the match is over. At the end of the match, each user can view the other user's playing cards. Viewing the other user's playing cards allows each user to learn about other characters from other books and thus the users may be interested in reading the necessary books and answering the playing card questions to obtain the opponent's cards (248).

In some implementations, the system may initiate various minigames during the match (250). The minigames can include a micro puzzle or a quick time event. A minigame may be initiated if the selected theme indicated that the one or both of the users should play a minigame. In a micropuzzle, the system may present a quote from a book and both users attempt to rearrange the quote in the correct order. In instances where the micropuzzle was initiated during theme selection, the quote may originate from one of the books associated with one of the playing cards of one of the users. For example, if one of the users has a Mr. Darcy character playing card, then the micropuzzle may feature a quote from Pride and Prejudice. In some implementations, a micropuzzle may be initiated to break a tie. If one of the playing cards involved in the tie depicts Atticus Finch, then the micropuzzle may feature a quote from To Kill a Mockingbird.

Another type of minigame is a quick time event. In some implementations, a quick time event is not necessarily related to a book. For example, a quick time event may involve the display 105 being covered with virtual mist and a user has to wipe away the virtual mist. The user who wipes away the virtual mist wins the quick time event. Another example of a quick time event is selecting the center of a moving target. A moving target moves around the display 105. Each user attempts to select the center of the moving target within an allotted time. Each user may either be allowed to attempt to select the center of the moving target only one time or be allowed to attempt to select the center of the moving target multiple times within the allotted time. The winner of the quick time event is the user who is closest to the middle of the moving target. In some implementations, quick time events may be used to break a tie.

FIG. 3 is an example screen shot of a book library 300. The book library 300 contains books 305-1, 305-2, 305-3, . . . , 305-n. The books 305-1, 305-2, 305-3, . . . , 305-n may be stored in the memory device 110. A user may select book 310 to read. The library 300 may display the books 305-1, 305-2, 305-3, . . . , 305-n stored in the memory device 110 or just a subset of the books 305-1, 305-2, 305-3, . . . , 305-n. The library 300 may have a maximum number of books 305-1, 305-2, 305-3, . . . , 305-n that the library 300 can display. The maximum number of books 305-1, 305-2, 305-3, . . . , 305-n may be influenced by the size of the display 105 or the resolution of the display 105 or both so that the titles of the books 305-1, 305-2, 305-3, . . . , 305-n remain legible. For example, the library 300 may be able to display a maximum of ten books 305-1, 305-2, 305-3, . . . , 305-10 and a user can scroll or swipe the display 105 to view additional books 305-10, 305-12, 305-13, . . . , 305-n.

A user may add books to the library 300 by downloading books from an electronic bookstore. In some implementations, the books 305-1, 305-2, 305-3, . . . , 305-n are annotated with playing card data. The playing card data allows a user to answer questions associated with each of the books 305-1, 305-2, 305-3, . . . , 305-n and earn a playing card. In some implementations, the books 305-1, 305-2, 305-3, . . . , 305-n are not annotated with playing card data. The books 305-1, 305-2, 305-3, . . . , 305-n may be selected for reading but the user will not be able to answer questions associated with each of the books 305-1, 305-2, 305-3, . . . , 305-n to earn a playing card.

FIG. 4 is an example screen shot for reading a book 405. The book 405 was selected by a user from the library 300 for reading. The book 405 contains text 410. A user may navigate from page to page to display additional text by selecting a next page or previous page icon or by swiping the display 105. On various pages of the book 405 are activity indicators. In some implementations, the activity indicators are selectable icons such as selectable icon 415. A user may select the selectable icon 415 to initiate an activity associated with the book. In some implementations, the activity is a challenge question, or playing card question, related to the text of the book. The student may select the selectable icon 415 to answer the playing card question or may continue to read the book 405 without selecting the selectable icon 415. In some implementations, the selectable icon 415 may be located in the margin of the book 405. In some implementations, the selectable icon 415 may be embedded in the text 410. In some implementations, the selectable icon 415 may be part of the text 410 that is written in a different font, underlined, bolded, or somehow distinguished from the rest of the text 410.

In some implementations, each selectable icon 415 may be paired with a playing card question. For example, the selectable icon 415 may be located on a particular page of the book 405 and the playing card question paired with the selectable icon 415 may be related to the particular page. In some implementations, the selectable icon 415 may change if the user has answered the playing card question correctly. For example, the selectable icon 415 may be displayed in color before the user answers the playing card question correctly. When the user answers the playing card question correctly, the selectable icon 415 may be displayed in black and white. In some implementations, the selectable icon 415 may also change if the user has incorrectly answered the playing card question. For example, the selectable icon 415 may include an “X” where the user answered the playing card question incorrectly.

FIG. 5 is an example screen shot of a playing card question 500 related to a book. The playing card question 500 includes question prompt 505 and multiple choice answers 510. The user selects one of the multiple choice answers 510 and selects the answer icon 515. If the specified criteria of the playing card question 500 are met, then the user is awarded a playing card. For example, if the user answers the question 500 correctly, then the user is awarded a playing card. In some implementations, the awarded playing card is related to the question 500. For example, if the question 500 is related to Sherlock Holmes, then the awarded playing card may be a Sherlock Holmes playing card.

In some implementations, question 500 may include a selectable skip icon for skipping the question. For example, if the user does not know the answer to question 500, then the user may select the selectable skip icon to not answer the question and return to the book.

FIG. 6 is an example screen shot of playing card 600 related to a book. The playing card 600 may depict either a literary character from a book or an author. Each playing card is assigned a specific theme indicating the energy required to use it, and contains a description of the character or author, and gameplay actions based on that character or author's personality. For example, the playing card 600 may depict Tom Sawyer, or the playing card 600 may depict Mark Twain. A playing card 600 that depicts a literary character may be a character card. A playing card 600 that depicts an author may be an author card. The playing card 600 may include a character name 605. The character name 605 identifies the name of the character or author depicted on the playing card 600.

The playing card 600 may include a character image 610. The character image 610 is an image of the character or author depicted in the playing card 600. The character image 610 may be animated such that the character image 610 moves while the playing card 600 is displayed on the display 105. The playing card 600 includes a card theme 615. The card theme 615 identifies the game turn themes where a user can play the playing card 615. Game turn themes may be identifies by a user rolling a die or spinning a spinner. The die or the spinner lands on a particular game turn theme, then a user collects energy of that theme and is stored in their energy pool 815. For example, if the spinner lands on the “Mystery” theme, then a user collects an energy that allows them to use cards with that theme.

The playing card 600 may include a card shelf life 620. The card shelf life 620 represents a number of turns that the playing card 600 stays in play. The card shelf life 620 reduces by one each turn until it reaches zero. Once the card shelf life 620 reaches zero, the playing card 600 is removed from play for the remainder of the game. For example, if a playing card 600 has a card shelf life 620 of three, then the playing card 600 will be in play for three turns.

The playing card 600 may include a list of card actions 625. The card actions 625 include a list of attributes of the playing card 600. The attributes may include actions that the playing card 600 can perform during game play such. For example, a playing card depicting the character of Alice from Alice in Wonderland may have an action involving a flamingo mallet. A playing card depicting Sherlock Holmes may have an action involving martial arts. Each attribute may be not be available during each turn of the game. In some implementations, playing card actions can only be played when a user has accumulated and placed enough theme energy that matches the particular playing card action on a playing card. In some implementations, some attributes may be locked when a playing card is introduced into a game. In subsequent turns, additional attributes may be unlocked and available during came play. For example, a playing card depicting Bill Sikes from Oliver Twist may have an attribute for beating. The beating attribute may only be available after the Bill Sikes card has been in the game for two turns.

In some implementations, an author playing card may have an additional effect on a character playing card that depicts a character from one of the author's books. The author playing card may boost the statistics of the character playing card by a particular amount or may unlock additional attributes sooner in the game play or attributes that may not be available unless the author card is present. For example, a Tom Sawyer character card may receive an increase in one point for each statistic when the Tom Sawyer card is played with a Mark Twain author card.

FIG. 7 is an example screen shot of a card collection 700. The card collection 700 includes earned cards 705-1, 705-2, . . . , and 705-n and unearned cards 710-1, 710-2, . . . , and 710-n. The earned cards 705-1, 705-2, . . . , and 705-n are displayed in the card collection 700 with the character image or author image facing up. In some implementations, some of the playing cards, such as playing card 705-1, may have additional actions or attributes that playing cards 705-2 or 705-3 may not have. The unearned cards 710-1, 710-2, . . . , and 710-n are displayed in the card collection 700 with the character image or author image facing down. In some implementations, the card collection contains a slot for each available card. For example, if there are one-hundred possible playing cards that a user can earn, and the user has earned thirty of them then the playing cards that the user has earned are shown with the character image or author image facing up. The other seventy playing cards are shown with the character image or author image facing down.

The card collection 700 contains an experience bar 715. The experience bar 715 indicates the level of experience earned by the user whose card collection 700 is displayed. In some implementations, a user may earn experience points by winning a game, by reading books, by answering playing card questions, or by any combination of the three. The card collection 700 also contains a rank 720 for the user whose user card collection 700 is displayed. The rank 720 may be related to the number of books the user has completed, the number of playing cards that the user has earned, the number of games the user has played, or any combination of the three.

FIG. 8 is an example screen shot of a playing card battle 800. The playing card battle 800 includes a user's active playing cards 801 and 802 and an empty playing card slot 803. The user's inactive cards 805 are viewable by the user in the playing card battle 800 but are not in play. The user's stored theme energy 815 is viewable in the playing card battle 800. The user may move one of the inactive playing cards 815 to the empty playing card slot 803. The user's opponent's selected playing cards 810 are viewable to the user, but user's opponent's inactive cards are not viewable to the user.

FIG. 9 is an example screen shot of an example micro puzzle 900. The micro puzzle 900 is a mini game where the user rearranges word tiles to create a quote from a book. The micro puzzle includes word tiles 905, 910, 915, and 920. A user can drag each word tile around the screen and place it into a slot, such as slot 925. Once the user places each word tile in the correct slots to create the quote, the timer 930 stops. In some implementations, the micro puzzle 900 may be used to break a tie during a playing card round between two players. In some implementations, the users may compete in a micro puzzle instead of a playing card match when the theme selected at the beginning of the round as during stage (236).

FIG. 10 is an example screen shot of a quick time event 1000. The quick time event 1000 presents the user with a moving circle 1005. The moving circle 1005 moves around the display 105. In some implementations, the user attempts to select the middle of the moving circle 1005 within a specific period of time. The user received only one attempt to select the middle of the moving circle 1005. In some implementations, the user may attempt to select the middle of the moving circle 1005 as many times as possible within a specific period of time. The user competes with another user to select as close to the middle of the moving circle 1005 as possible. The marker 1010 indicates the location of the user's selection. The quick time event 1000 may be used to break a tie during a round of card play.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a user computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request to view a book;
displaying the book on a display device;
displaying an activity indicator at a location in the book;
receiving a selection of the activity indicator;
in response to receiving the selection of the activity indicator, displaying an activity on the display device, the activity being associated with the book and the location of the activity indicator within the book, wherein the activity is configured to solicit a response from a user;
receiving a response to the displayed activity from the user;
determining that the response to the activity meets specified criteria; and
based on determining that the response to the activity meets the specified criteria, awarding a playing card that is associated with the book, the playing card configured to be used in a card game played by the user.

2. The method of claim 1, wherein the playing card depicts a character from the book.

3. The method of claim 1, wherein the playing card depicts an author of the book.

4. The method of claim 1, wherein the activity indicator comprises an icon that is embedded within text of the book.

5. The method of claim 1, wherein the activity is a challenge question, the response is an answer to the question, determining that the response meets specified criteria includes determining that the answer is correct.

6. The method of claim 1, based on determining that the response to the activity meets the specified criteria, adjusting the activity indicator to indicate that the response to the activity meets the specified criteria.

7. The method of claim 1, wherein the activity includes an option to skip the activity.

8. The method of claim 1, wherein the activity indicator is located in a margin of the book.

9. The method of claim 1, wherein the playing card is associated with the activity.

10. The method of claim 1, comprising:
receiving a request to view the playing card, other awarded playing cards, and other initially provided playing cards;
displaying the playing card, the other awarded playing cards, and the other initially provided playing cards; and
receiving, from the user, a selection of a subset of the playing card, other awarded playing cards, and other initially provided playing cards for use in the card game.

11. A system comprising:
an electronic device comprising:
a display device;
one or more processing devices;
one or more memory devices storing instructions that, when executed by the one or more processing devices, cause the one or more processing devices to implement:
an e-reader configured to:
receive a request to view a book;
display the book on the display device;
display an activity indicator at a location in the book;
receive a selection of the activity indicator;
an activity layer module configured to:
in response to receiving the selection of the activity indicator, display an activity on the display device, the activity being associated with the book and the location of the activity indicator within the book, wherein the activity is configured to solicit a response from a user;
receive a response to the displayed activity from the user;
determine that the response to the activity meets specified criteria; and
based on determining that the response to the activity meets the specified criteria, award a playing card that is associated with the book, the playing card configured to be used in a card game played by the user; and
a gaming module configured to implement:
the card game.

12. The system of claim 11, wherein the playing card depicts a character from the book.

13. The system of claim 11, wherein the playing card depicts an author of the book.

14. The system of claim 11, wherein the activity indicator comprises an icon that is embedded within text of the book.

15. The system of claim 11, wherein the activity is a challenge question, the response is an answer to the question, determining that the response meets specified criteria includes determining that the answer is correct.

16. The system of claim 11, based on determining that the response to the activity meets the specified criteria, adjusting the activity indicator to indicate that the response to the activity meets the specified criteria.

17. The system of claim 11, wherein the activity includes an option to skip the activity.

18. The system of claim 11, wherein the activity indicator is located in a margin of the book.

19. The system of claim 11, wherein the playing card is associated with the activity.

20. The system of claim 11, wherein the activity layer module is further configured to:
receive a request to view the playing card, other awarded playing cards, and other initially provided playing cards;
display the playing card, the other awarded playing cards, and the other initially provided playing cards; and
receive, from the user, a selection of a subset of the playing card, other awarded playing cards, and other initially provided playing cards for use in the card game.
